(19) United States
(12) Patent Application Publication
(10) Pub. No.: US 2025/0116638 A1
(43) Pub. Date: Apr. 10, 2025

(54) CHROMATIC DATA PROCESSING DEVICE, METHOD, AND PROGRAM

(71) Applicant: HITACHI HIGH-TECH SCIENCE CORPORATION, Tokyo (JP)

(72) Inventors: Masato FUKUDA, Tokyo (JP); Masahito ITO, Tokyo (JP)

(21) Appl. No.: 18/899,891

(22) Filed: Sep. 27, 2024

(30) Foreign Application Priority Data
Oct. 4, 2023 (JP) 2023-172997

(51) Int. Cl. G01N 30/86; G01N 30/02

(52) U.S. Cl. CPC G01N 30/8637; G01N 30/8675; G01N 2030/027

(57) ABSTRACT

Disclosed is a chromatographic data processing device to easily obtain peak characteristic points in a short period of time with less susceptibility to noise. The chromatographic data processing device includes a partial regression curve calculation unit configured to obtain a partial regression curve for each of a plurality of data groups in which a predetermined number of measured time-series data are combined, a partial characteristic point acquisition unit configured to obtain a partial characteristic point for each of the obtained partial regression curves, and a peak characteristic point acquisition unit configured to obtain a peak characteristic point in the measured time-series data pieces on the basis of the partial characteristic points.

### CROSS REFERENCE TO RELATED APPLICATION

The present application claims priority to Japanese Patent Application No. 2023-172997, filed Oct. 4, 2023, the entire contents of which is incorporated herein for all purposes by this reference.

### BACKGROUND OF THE DISCLOSURE

### 1. Field of the Disclosure

The present invention relates to a chromatography technique such as a liquid chromatograph and, more particularly, to a data processing device, method, and program for chromatographic data.

### 2. Description of the Related Art

In chromatography, the type and amount of each substance contained in an analysis target sample are determined from waveform data in which the horizontal axis indicates time and the vertical axis indicates signal intensity. In this process, peak characteristic points such as a start point at which the signal intensity starts rising and an end point at which the signal intensity stops falling are detected, and waveform processing is performed on the basis of data detected by a chromatographic device.

As to the above-mentioned waveform processing technique, there is known a related art (for example, Patent Document 1) to provide “a chromatograph device capable of easily performing curve fitting using a nonlinear least-squares method even for chromatograms in which multiple overlapping peaks exist”. Specifically, the related art discloses a chromatographic data processing device that processes chromatic data obtained by separating an analysis target sample through a column and detecting substances in the sample. In the device, fitting processing is applied to each peak with respect to an arbitrary time region, in which a plurality of peaks are present in the chromatogram from a faster region or slower time region, and by subtracting processed peaks from the chromatogram in the arbitrary time region, the plurality of peaks of the chromatogram are decomposed.

In addition, there is known another related art (see Patent Document 2) to provide “a chromatographic data processing device capable of easily finding an appropriate characteristic point”. Specifically, the related art discloses “a chromatographic data processing device that processes plot data measured with a chromatograph, the device being equipped with an arithmetic processing unit functioning as: a virtual curve calculation unit for obtaining a virtual curve on the basis of the plot data; a provisional characteristic point acquisition unit for obtaining a provisional characteristic point on the basis of the obtained virtual curve; and an actual plot data characteristic point extraction unit for extracting an actual plot data characteristic point corresponding to the provisional characteristic point from the plot data”.

### DESCRIPTION OF RELATED ART

### Patent Document

(Patent Document 1) Japanese Patent Application Publication No. 2006-177980
(Patent Document 2) Japanese Patent Application Publication No. 2019-174399

### SUMMARY OF THE DISCLOSURE

In techniques such as the one disclosed in Patent Document 1, virtual curves and characteristic points obtained are often greatly affected by noise.

In addition, techniques such as the one disclosed in Patent Document 2 require a long time to determine the appropriate type of regression curve when obtaining characteristic points. In other words, it is necessary to consider which type of regression curve is to be selected, as well as which range of the measurement data on the time axis to be regressed and searched for characteristic points.

The present invention has been made to solve the above-mentioned problems, and an objective of the present invention is to easily obtain a peak characteristic point in a short period of time with less susceptibility to noise.

In order to achieve the above-mentioned objective, the present invention provides a chromatographic data processing device that performs data processing based on plot data measured with a chromatograph, the device including: a partial regression curve calculation unit configured to obtain, respectively, partial regression curves for a plurality of data groups where a predetermined number of measured time-series data are combined; a partial characteristic point acquisition unit configured to obtain a partial characteristic point for each of the obtained partial regression curves; and a peak characteristic point acquisition unit configured to obtain a peak characteristic point in measured time-series data on the basis of the partial characteristic points.

This allows partial regression curves to be obtained from a predetermined number of time-series plot data pieces, whereby characteristic points can be obtained in a relatively short time. Moreover, since it is easy to regress with a relatively low order function, it is also easy to suppress regression curves from being skewed by noise.

The present invention enables to easily obtain peak characteristic points in a short period of time with less susceptibility to noise.

### BRIEF DESCRIPTION OF THE DRAWINGS

FIG. 1 is a block diagram illustrating a schematic construction of a chromatograph;

FIG. 2 is a block diagram illustrating a schematic construction of a chromatographic data processing device;

FIG. 3 is a diagram illustrating an example of a chromatogram;

FIG. 4 is a diagram illustrating a schematic example of data for data processing;

FIG. 5 is a diagram illustrating an example of a curve related to data processing; and

FIG. 6 is a diagram illustrating an example of an envelope method in a scanning PCF.

### DESCRIPTION OF THE PREFERRED EMBODIMENTS

Hereinafter, embodiments of the present invention will be described in detail with reference to the accompanying drawings.

### (Overview)

### (Construction of Liquid Chromatograph 100)

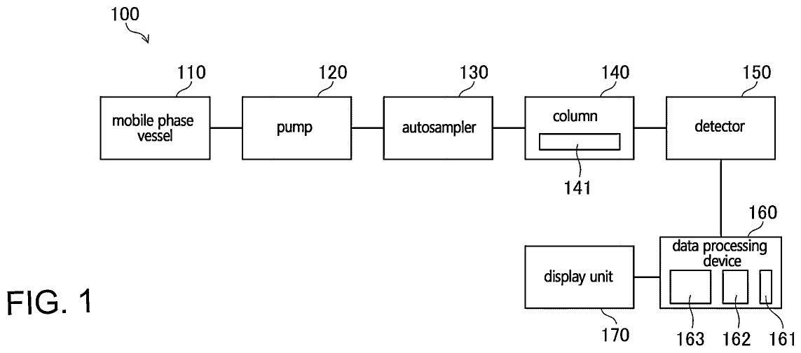

FIG. 1 illustrates a schematic construction of a liquid chromatograph 100. The liquid chromatograph 100 includes a mobile phase vessel 110 in which liquid, which is a mobile phase, is stored, a pump 120 that pumps the mobile phase, an autosampler 130 that injects a sample, a column 140 that is maintained at a constant temperature by a column oven 141 and which separates components contained in the sample, a detector 150 that detects the separated components, a data processing unit 160 that processes the detection results, and a display unit 170 that displays the processing results. Since the components of the liquid chromatograph 100 may be configured in the same manner as those of a conventional chromatograph, except for the processing content of the data processing unit 160, a detailed description thereabout will be omitted here.

### (Detailed Construction of Data Processing Unit 160)

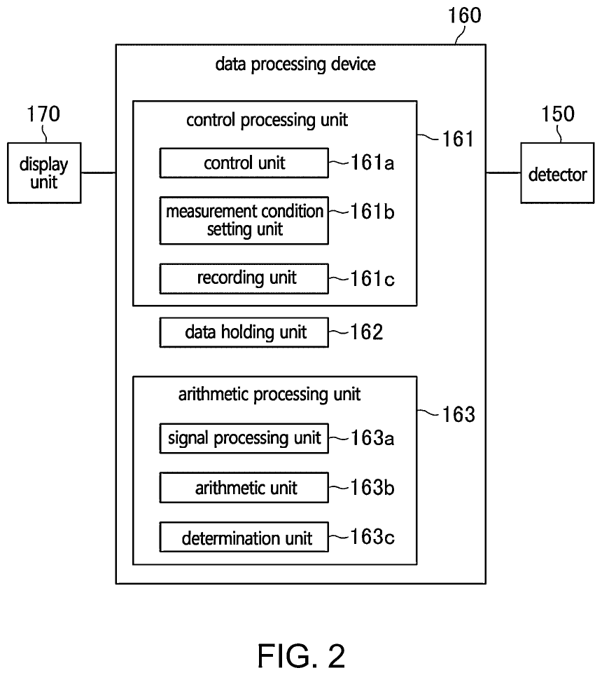

Referring to FIG. 2, the data processing unit 160 includes a control processing unit 161, a data holding unit 162, and an arithmetic processing unit 163.

The control processing unit 161 controls the overall operation of the liquid chromatograph 100, and includes a control unit 161a, a measurement condition setting unit 161b that sets measurement conditions in response to operations such as those performed on an operation panel not shown in the drawing, and a recording unit 161c that records measurement results and other data.

The data holding unit 162 is designed to retain data processed on the basis of the measurement results and other data.

The arithmetic processing unit 163 performs processing based on the measured data and functions as a partial regression curve calculation unit, a partial characteristic point acquisition unit, and a characteristic point acquisition unit. Specifically, for example, the arithmetic processing unit 163 includes a signal processing unit 163a that performs D/A conversion of analog signals output from the detector 150, an arithmetic unit 163b that extracts and analyzes characteristic points, and a determination unit 163c that makes a determination on analysis results.

### (Data Processing Operation)

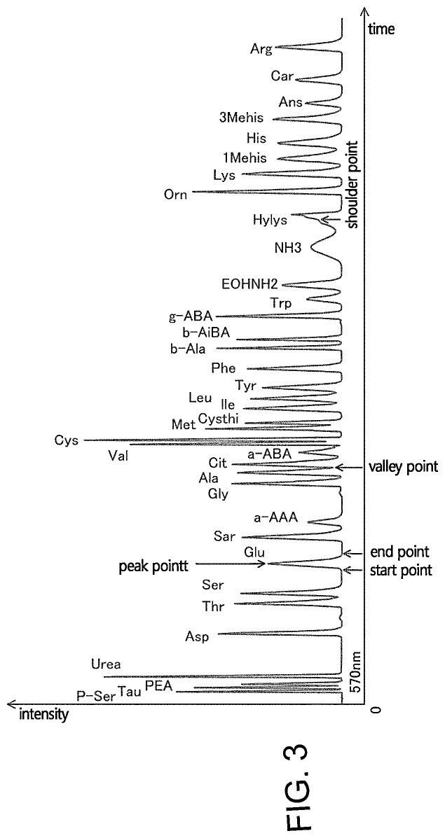

In the liquid chromatograph 100, the measurement operation produces waveform data, for example, data as shown in FIG. 3. In the waveform data, the horizontal axis indicates time, and the vertical axis indicates signal intensity.

Since the relationship between times and components is known, each of the components contained in an analysis target sample can be identified by the retention times on the horizontal axis, by referring the times at which the peak apexes occur in the waveform data (qualitative processing).

In addition, the amount of a component contained in the analysis target sample is calculated by the peak area of the waveform data (quantitative calculation processing).

Typically, such processing is performed by extracting peak apexes or peak characteristic points such as a peak start point, a peak end point, a valley point, and a peak shoulder point as shown in FIG. 3, and by setting baseline line segments on the basis of the extracted points.

The extraction of peak characteristic points is performed by the arithmetic processing unit 163 as described below.

(Extraction of Peak Characteristic points)

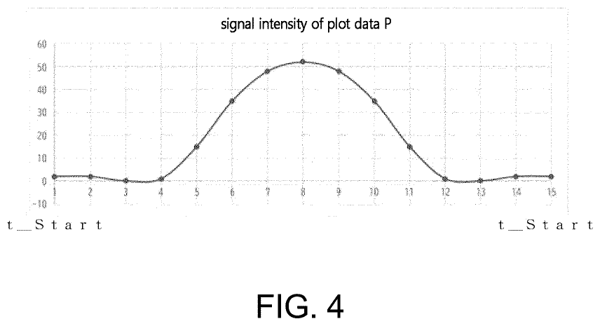

Discrete data actually detected by the detector 150, for example, plot data P1 to P1000 at 1000 points per predetermined sampling period, is acquired. Among the plot data P1 to P1000, for example, consecutive plot data P_Start to P_End in a predetermined period time zone ranging from a time point t_Start to a time point t_End as shown in FIG. 4 are set as processing targets. Here, the time point t_Start and the time point t_End may be predetermined or may be specified by the user.

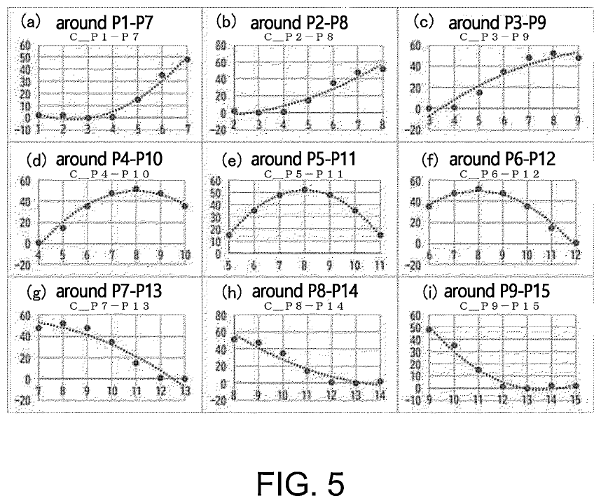

The plot data P_n1 to P_n7 of seven consecutive points in a time zone from a start point to an end point are shifted by one point and selected. For example, referring to FIG. 5, quadratic curves C, which are partial regression curves that approximate the seven-point plot data P_n1 to P_n7 are obtained. The quadratic curves C are obtained, for example, through the least-squares method. Curves of third-order or higher-order functions or Gaussian curves can be used, and various approximation methods other than the least-squares method can be used.

For example, when the start point and end point of the time zone is P1 and P15, respectively, a quadratic curve C_P1-P7 based on plot data P1 to P7, a quadratic curve C_P2-P8 based on plot data P2 to P8, . . . , a quadratic curve C_P8-P14 based on plot data P8 to P14, and a quadratic curve C_P9-P15 based on plot data P9 to P15 are obtained.

That is, when there are m pieces of plot data for m points in a time zine, and n (m>n) pieces of consecutive plot data for n points are selected, m−n+1 quadratic curves C are obtained.

For the group of quadratic curves C thus obtained for the entire time zone, it is checked whether differential characteristic points (local maximum points and local minimum points), which are partial characteristic points, are included in the range of selected data point groups in each quadratic curve. When the differential characteristic points are included, time points corresponding to the respective differential characteristic points are considered as candidate time points for peak characteristic points (a peak apex, a peak start point, and a peak end point). On the basis of the data points at the time points corresponding to the differential characteristic points, the data points are considered to be the peak characteristic points (a peak vertex, a peak start point, and a peak end point) of the approximate waveform of the time-series data (plot data) of the detected signal, and the peak characteristic points are output.

Specifically, for a group of quadratic curves C obtained for the full range of the time zone, peak characteristic points are obtained according to the procedure described below.
(1) That is, for example, points on the quadratic curve C at the time point for the plot data P2 of FIG. 5(a) or for the plot data P13 of FIG. 5(i) are considered to be partial characteristic points that are local minimums. The points on the quadratic curve C at the time point for the plot data P8 in FIG. 5(d) to FIG. 5(f) may be considered to be partial characteristic points that are local maximum points.
(2) However, when the time points at which such local maximum points and local minimum points occur are not within the time range for which each of the partial regression curves is obtained, the time points may be ignored. In addition, when the time points are within the time range for which the respective partial regression curve is obtained, for example, when the time points are within ±2 sampling periods from the center of a corresponding one of the time ranges, the time points are considered as partial characteristic points.
(3) In all the examples illustrated in FIGS. 5(d) through 5(f), the local maximum point occurs at the time point of plot data P8. However, when there are multiple quadratic curves with such local maximum point in a given time range, and the time points of the local maximum points are different from each other, the local maximum points may be summarized as below.

For example, when the difference between the time points of the local maximum points falls within two sampling periods (range of sense), one peak may be assumed to exist, and the peak characteristic point may be taken at the time point at which the maximum value among the local maximum points or raw data is the largest. Since the range of sense as described above is set according to, for example, the expected peak width or sampling period, the range is not limited to fixed settings but may be specified by the user.

Here, liquid chromatography is a measurement method in which the measured value changes with time, and the measured values are a series of values per unit time. On the other hand, the data collected per unit time varies depending on the separation performance of the column and the effect of noise. Therefore, a certain range of expected data can be considered as a single inseparable mass of events (represented by a single piece of data).

For example, although there are local maximum points at time points more than two sampling periods apart, when the raw data of all plots at time points in the time zone are within a predetermined noise width, these pieces of plot data are determined to be that of a single peak affected by noise. For example, the one with the larger raw data may be considered as the peak characteristic point.

Here, the predetermined noise width is, for example, as described below. In other words, a certain amount of width is added to the measurement data due to various measurement factors. This value is defined only by the width. Although there are a non-periodic component and a periodic component, both are considered as noise components when the correlation between the period and the measured peak is not constant. In other words, the noise width in the measured value is considered an uncertain value. In other words, even in the case that “measured value A>measured value B”, since “(measured value A-measured value B)<noise width”, the difference between the exact values of A and B is uncertain. The noise amplitude as described above can be set, for example, depending on the amplitude of the measured value at a time point sufficiently far from the peak point.

As described above, partial regression curves can be obtained from a predetermined number of pieces of time-series plot data, whereby characteristic points can be obtained in a relatively short time. Moreover, since it is easy to regress with a relatively low order function, it is also easy to suppress regression curves from being skewed by noise. In particular, an objective process can be easily expedited because there is no need to select the type of regression curve or the time range for obtaining the regression curve.

In addition, the set of plot data for obtaining each partial regression curve is not limited to plot data shifted by one sampling period, and plot data shifted by, for example, two or more sampling periods can be used if peak characteristic points can be obtained with the required accuracy. Each set of plot data is not necessarily limited to consecutive plot data, but may be skipped or bunched data.

### (Scanning Complementally Curve-Fitting (Scanning CCF) and Scanning Partial Curve-Fitting (Scanning PCF))

The Savitzky-Golay method is a type of moving average smoothing method, but the objective of suppressing noise effects is common between the method and the present embodiment. The moving average has a window with a certain period of time, and a representative value is assigned to a representative point positioned at the central time point of the time window. The window has, for example, seven or nine points, and is swept backward in time, so that the representative value of the detection signal at the representative time point is replaced with the moving average value in succession. Alternatively, the window may be swept forward. In any case, several points of signal data within a time window are collected with the function y=f(t), and the value of an objective variable y is mapped to a time point t, which is an explanatory variable. By switching the weighting factors in the Savitzky-Golay method, differential coefficients such as y=f′(t) can also be calculated. The smoothing method simply cancels out noise, but the purpose of the present embodiment is to find a true curve.

The present embodiment also uses a time window, and the time window is swept in the same manner as in the Savitzky-Golay method and others. However, the present embodiment has the characteristics of the scanning CCF or scanning PCF as described below because the virtual curve is regressed in each time window, rather than a representative value is assigned to the central time point.

In the case of a quadratic curve, the apex or valley point may be obtained. For example, when analyzing an area near the apex, the coordinates t and y of the apex are determined for each window. That is, the coordinates are the time point t and the signal intensity y of the apex as a differential characteristic point of each regression curve. When the apex coordinates (t, y) do not nearly change even though the window is shifted a little, the apex is determined as a true apex. The same is true for a valley point. This method of finding differential characteristic points is in the category of scanning CCF.

This method is not limited to the first-order and second-order polynomials, but can be extended to higher-order polynomials. This virtual curve is not limited to probability density functions such as a normal distribution or to even analytical mathematical functions such as exponential and logarithmic functions. The virtual curve can be extended to even arbitrary functions. This method is called scanning complementary curve fitting (scanning CCF) because the curve fitting process, which is performed supplementally for each time window, is swept. The name is derived from the fact that the curve fitting process is used supplementarily to obtain differential characteristic points.

On the other hand, the method of obtaining the true curve is called scanning partial curve-fitting (PCF), in the sense that the method uses a similar time window for the entire true curve and partially scans the curve fitting process one after another. The scanning PCF does not supplementarily use the curve fitting but primarily uses the curve fitting to obtain the true curve. The scanning CCF is used to search for differential characteristic points, while the scanning PCF is used to search for a true curve.

Furthermore, as a similar signal analysis method, there is spline interpolation, such as cubic spline. Spline interpolation also uses a polynomial, and it is a method of interpolating between real data points. However, it is not a method of finding a true curve buried in noise. In addition, the moving average described above does not have an interpolation function. The scanning PCF eliminates the effects of noise and also has an interpolation function.

### (Embodiments of Scanning CCF and Scanning PCF)

While the scanning CCF finds differential characteristic points such as apex and valley points, the scanning PCF examines the difference (i.e., residual) between virtual curves in the overlapping zone of two windows. For example, by evaluating the residual sum of squares of two virtual curves, it is possible to determine whether the virtual curves match or do not match each other. By determining a group of virtual curves that match each other to be a true curve, the true curve can be found for the entire time window zone. In practice, when the vertical y-coordinates coincide within a certain tolerance width for each time window, the coincident virtual curves are extracted and connected to each other to generate a true curve. The scanning PCF has a characteristic of finding a true curve and is different from a smoothing process that cancels out noise components.

In the scanning PCF, it is desirable to use second-order or third-order polynomials for virtual curves. However, this does not mean that regression lines cannot be used for scanning PCFs because a special case of a curve is a linear line.

As described above, the main purpose of the present embodiment is to examine the difference between adjacent regression curves. In the case of a linear line, the extent to which the first-order differential coefficients, i.e., slopes are the same or are different from each other is examined for each time window. When the slops are almost the same, the slopes can be determined to be almost constant for the time zone in which the slopes are the same. When the first-order differential coefficient, i.e., the change of the regression line, is determined, regression to a first-order polynomial, i.e., a linear line is sufficient. The present embodiment is a method of finding a true curve including a true linear line from scattered, i.e., noise-superimposed, detection signal data. At the same time, when the regression function is a differentiable function, the differential coefficient of the function can also be calculated.

A shoulder point, that is an inflection point that characterizes a shoulder peak can also be found by extending this logic. The inflection point exists at the time point at which the second-order partial differential coefficient is zero. With regression to a quadratic function for each time window, first-order differential coefficients are obtained, while with the observation of the change per unit time, inflection points can be obtained. The first-order derivative coefficients are also found as first-order derivative curves in the scanning PCF, rather than as representative values at respective time points as in the smoothing process.

In the smoothing process, the time windows are mainly shifted from one to another, but in this embodiment, it is not necessarily required to shift the time window by one frame. Sweeping can be made with single or double skipping. The number of points in a time window may be selected from 7, 9, 11, etc. In addition, the sampling period and the number of points in a time window can be automatically calculated using the expected peak width that is input. In the case of single or double skipping, a bunching process in which data points are summed up can be performed. In fact, both the scanning PCF and scanning CCF should have 20 to 30 data points per peak, or at most 50 points per peak. It is important in the present embodiment to automatically calculate the sampling period, the number of bunching points, etc., using the representative peak width as an input value. In other words, the typical sampling period for high performance liquid chromatography (HPLC) is few hundreds of milliseconds, while the typical sampling period for ultra-high performance liquid chromatography (UHPLC) is few tens of milliseconds.

In the case of scanning CCF, there are several possible methods for comparison between time windows. For example, when the time point t of each valley point in a time window is within a range of plus or minus sampling period, the measurement can be considered stable. Similarly, another criterion is that the vertical axis y-value of the valley point falls within a certain tolerance width. It is also possible to set a tolerance width in the form of vertical and horizontal rectangles for the coordinates (t, y).

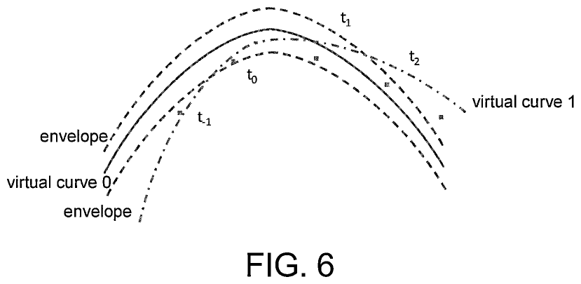

In the case of scanning PCF, there is also a tolerance width when fining a true curve. The scanning PCF is suitable in the case that one of the two virtual curves to be compared has an envelope with a certain width of, for example, ±several mV in the vertical axis direction, and the other virtual curve is present inside the envelope. The scanning PCF is not suitable for the case in which the virtual curve is outside the envelope. In some cases, envelopes are more convenient than the aforementioned comparison of residual sums of squares. Referring to FIG. 6, further details will be described.

As a more advanced technique, a method of considering a contribution ratio may be considered. A series of time windows are numbered T₁, T₂, and T₃, and good or bad as a result of the regression calculation process is determined by the contribution ratios R₁², R₂², and R₃². The more successful the regression process is, the better the explanation is provided by the regression curve, and the closer the contribution ratio is to 1. The regression curve of which the regression progresses well is weighted appropriately and used as an indicator to find the true curve. In addition, the method of using the contribution ratio as an indicator can also be used to find differential characteristic points.

Finally, when the first-order differential coefficients are obtained from the true curve by scanning PCF, the start or end point of the peak can also be found. This can be interpreted as finding a differential characteristic point characteristic point. The true curve obtained by the scanning PCF is the true peak waveform itself, so that accurate retention times and peak areas can be calculated.

### (Simple Scanning PCF)

For simplicity, for example, in the case of a time window with five data points, there is a weighted regression method that calculates the data using the least-squares method by assigning weight 1 to the central data point, weight ⅔ to the next data point, and weight ⅓ to the next data point, and so on. Then, a group of coefficients of a regression curve, such as a quadratic polynomial, is assigned to the time point of the central point. By sweeping this central time point, each group of coefficients is successively assigned to the central time point thereof. When performing interpolation, these adjacent regression curves are mixed by an internally dividing method. That is, at the time point of interest, the ratio of the regression curve at that time point is set to 1.0, and the ratio of the regression curve at the next time point is set to 0.0 and added. At the dividing point between the interest time point and the next time point, each regression curve is mixed according to the ratio of the internally dividing point, depending on the time point difference. At the midpoint, each regression curve is mixed at a ratio of 0.5. At the neighboring time points, the ratio of the regression function at the neighboring time point is 1.0. The curve thus obtained is one true curve.

### (Enveloping Method)

There are cases where one of the two virtual curves matches with the other virtual curve within a certain tolerance width, and there are cases where they do not match. FIG. 6 illustrates an enveloping method. First, a virtual curve 0 is regressed using five data points actually measured before and after a representative time point t₀. There are five time points t₋₁, t₀, t₁, and t₂, starting from t₋₂. The subscripts are the time notation for the virtual curve 0.

Next, a virtual curve 1 is regressed by shifting one data point backward. It is evaluated how closely the virtual curve 1 matches the virtual curve 0. To this end, an envelope is placed above and below the virtual curve 0 as an input width. The virtual curve 1 overlaps the virtual curve 0 by four points t₋₁ to t₂ in terms of time notation. In the example of FIG. 6, the virtual curves 1 at two time points t₀ and t₁ of the four time points t₋₁ to t₂ are present inside the envelope. Therefore, it is considered that the virtual curve 0 and the virtual curve 1 match only at those two points. In this case, the true curve is calculated as expressed by Expression 1 below and is applied only at time points at which the virtual curves match. Here, y₀ represents a virtual curve 0, y₁ represents a virtual curve 1, and y represents a curve that is true (assumed to be true). The coefficient of the true curve y is the average of the coefficients of the virtual curves.

$$\begin{matrix}{y}_{0} = {a}_{0} + {b}_{0} t + {c}_{0} {t}^{2} … \\ {y}_{1} = {a}_{1} + {b}_{1} t + {c}_{1} {t}^{2} … \\ y = \frac{1}{( n + 1 )} {\sum }_{i = 0}^{n} {a}_{i} + t \frac{1}{( n + 1 )} {\sum }_{i = 0}^{n} {b}_{i} + {t}^{2} \frac{1}{( n + 1 )} {\sum }_{i = 0}^{n} {c}_{i} …\end{matrix} \qquad [ Expression 1 ]$$

In the case of FIG. 6, the true curve y is obtained by n=1 (n is the number of virtual curves used to derive the true curve minus 1), meaning that the virtual curve 0 and the virtual curve 1 are used, and in terms of time, the true curve y is applied only to the time zones t₀ and t₁ in which the virtual curve 0 and the virtual curve 1 match. Now that the true curve y is obtained, both a first-order derivative curve y′ and second-order derivative curve y″ thereof can be obtained from the differential coefficients of a polynomial.

Here, the relationship between the upper and lower envelope tolerance widths and the certainty of the true curve, that is, reliability will be described. A narrower tolerance width improves reliability, but increases the possibility that a neighboring virtual curve will not fall within the envelope. In the extreme case, only one true curve will be assigned to the central time point of a corresponding time window. Conversely, when the tolerance width is excessively wide, the number of target virtual curves from which the average value is calculated increases. Although the average value can be obtained, the variability increases, and the reliability decreases. One guideline for an appropriate tolerance width is preferably a few percent of the peak height. Of course, it is also possible to have the envelope tolerance width automatically entered on the basis of this few percent.

### (Methods for Time-Varying Regression Zone)

In the previous embodiment, the time zone of the five data points is shifted backward by one. When the virtual curves obtained from the previous five points fits the real data well, there are cases where the next sixth data point can be accounted for with a certain tolerance with. The next sixth data point can be imaged by the enveloping method described above, or it can be identified by the residuals between the virtual curve and the real data. For example, the average value of the residual sums of squares for the 5-point case is compared with the average value of the residual sums of squares for the 6-point case, and when the former is smaller, the regression process stops at the 5-point stage. Conversely, when the average value of the residual sums of squares obtained from the six points (latter case) is not large, the regression curve is determined to be extendable, and the regression process is performed again with a six-point time zone. As a result, a new virtual curve for the 6-point zone is obtained. The time zone to be regressed can be varied by repeating this process. This time-varying regression zone method differs from the enveloping method described above in that the time-varying regression zone method compares a virtual curve with a real data point sequence, rather than comparing two virtual curves with each other. It can also be extended to a method of comparing two virtual curves, for example, by shifting one of the possible curves obtained from a 7-point time zone to the next 5-point time zone that ends at the eighth data point. Only in the zone in which the two virtual curves match, the two virtual curves are connected to produce a true curve.

### (Gaussian Connection Using Machine Learning)

The ideal shape of a chromatographic peak is considered to be a normal distribution, that is, Gaussian distribution. In addition, it is often represented by a single probability density function, such as an exponentially modified Gaussian EMG, which represent a tailing peak. In light of the idea of the scanning PCF in the present embodiment, devised is a method that partially fits a Gaussian distribution and finally connect the partial curves to a true curve, without necessarily representing data as a single function. Simply describing, the peak can be divided into three vertically arranged sections: a section near the apex, a section near the midpoint near the inflection point, and a section near the baseline. Each section, i.e., the section around the Gaussian apex, the right and left sections around the midpoint, and the right and left sections around the baseline are approximated by respective Gaussians. The peak division is not limited to division into three sections, but the number of vertically divided sections may be four, five, or more. The three vertically divided sections may be divided into five zones in the time direction, the four vertically divided sections may be divided into seven zones in the time direction, and the five vertically divided sections may be divided into nine time zones.

It is desirable to apply machine learning when determining an appropriate number of divided sections, a function for regression among Gaussian, EMG, and possibly polynomial, etc. Numerous examples of chromatographic peaks are input into supervised machine learning and applied to individual analyses. Adding overlapping peaks, shoulder peaks, and other phenomena will add the process complexity, but the adaptability of the present embodiment will increase accordingly. The pre-input examples may be actually measured data or artificially generated chromatographic peaks.

Like the method of time-varying regression zone method described above, the method of connecting Gaussians using machine learning also compares virtual curves and actually measured time-series data.

What is claimed is:

1. A chromatographic data processing device that performs data processing based on plot data measured with a chromatograph, the chromatographic data processing device comprising:
a partial regression curve calculation unit configured to obtain, respectively, partial regression curves for a plurality of data groups where a predetermined number of measured time-series data are combined;
a partial characteristic point acquisition unit configured to obtain a partial characteristic point for each of the obtained partial regression curves; and
a peak characteristic point acquisition unit configured to obtain a peak characteristic point in measured time-series data, based on the partial characteristic points.

2. The chromatographic data processing device according to claim 1, wherein the regression curves are any one of second- or higher-order function curves and Gaussian curves.

3. The chromatographic data processing device of claim 2, wherein the plurality of data groups are data groups that are not aligned with one another on a time axis.

4. The chromatographic data processing device according to claim 3, wherein the partial characteristic point is at least one of a local maximum point and a local minimum point.

5. The chromatographic data processing device according to claim 2, wherein the peak characteristic point is any of a peak apex, a peak start point, and a peak end point.

6. A chromatograph comprising:
a chromatography unit configured to separate and measure a component contained in a sample; and
the chromatographic data processing device according to claim 1.

7. A chromatographic data processing method that performs data processing based on plot data measured with a chromatograph, the chromatographic data processing method comprising:
a partial regression curve calculation step of obtaining, respectively, a partial regression curves for a plurality of data groups where a predetermined number of measured time-series data are combined;
a partial characteristic point acquisition step of obtaining a partial characteristic point for each of the obtained partial regression curves; and
a peak characteristic point acquisition step of obtaining a peak characteristic point in measured time-series data, based on the partial characteristic points.

8. A chromatographic data processing method that performs data processing based on plot data measured with a chromatograph, the chromatographic data processing device comprising:
a partial regression curve calculation unit configured to obtain, respectively, partial regression curves for a plurality of data groups where a predetermined number of measured time-series data are combined;
a partial curve comparison unit configured to compare the respectively obtained partial regression curves with one another; and
an integrated regression curve acquisition unit configured to obtain a regression curve broader than each of the partial regression curves from the measured time-series data based on the comparison results.

9. A chromatographic data processing device that performs data processing based on plot data measured with chromatograph, the chromatographic data processing device comprising:
a partial regression curve calculation unit configured to obtain, respectively, partial regression curves for a plurality of data groups where a predetermined number of measured time-series data are combined;
a partial curve comparison unit configured to compare the respectively obtained partial regression curves with the time-series data; and
an integrated regression curve acquisition unit configured to obtain a regression curve broader than each of the partial regression curve from the measured time-series data based on the comparison results.
